(19) United States
(12) Patent Application Publication
(10) Pub. No.: US 2017/0282781 A1
(43) Pub. Date: Oct. 5, 2017

(54) AXLE STRAP WITH ATTACHABLE END PIECES

(71) Applicant: Ariens Company, Brillion, WI (US)

(72) Inventors: Von Roy Christiansen, JR., Prescott Valley, AZ (US); Gary D. Gates, Prescott Valley, AZ (US)

(21) Appl. No.: 15/090,514

(22) Filed: Apr. 4, 2016

(51) Int. Cl. B60P 7/08; A44B 13/00; F16B 1/00

(52) U.S. Cl. CPC B60P 7/0823; F16B 1/00; B60P 7/083; A44B 13/00; F16B 2001/0035

(57) ABSTRACT

An axle strap includes a strap, a first end piece disposed on a first end of the strap, and a second end piece disposed on a second end of the strap; wherein the first end piece and the second end piece are capable of coupling. The strap can be made of a high-strength fabric, and the first end of the strap and the second end of the strap can be looped. In an embodiment, the end pieces are made of a ferromagnetic material, preferably an iron alloy such as steel, and the coupling is ferromagnetic coupling. To obtain sufficient magnetic attraction one or more permanent magnet can be used. In another embodiment, the end pieces can be coupling by hook-and-loop fasteners attached to the ends of the strap adjacent the end pieces.

### BACKGROUND OF THE INVENTION

1. Field of the Invention

The present invention relates to towing equipment, and, more particularly to an axle strap with attachable end pieces.

2. Description of the Related Art

Towing a motor vehicle involves many tasks. One such task is to tie down the vehicle which can be accomplished using using axle straps. During set-up, the worker must wrap axle straps around the axles and then attach the axle straps to ratchet straps or other tie-down anchors. For each axle strap, this requires finding the end pieces, placing them through a hook of the ratchet strap, and then tightening the ratchet strap until the vehicle is properly secured. To accomplish the forgoing, a worker has to go underneath the vehicle and wrap the axle strap around the axle. Many times a towing vehicle worker will not be able to see clearly underneath the vehicle because of the absence of light. This is made worse during night and in inclement weather. Accordingly, it would be beneficial to provide axle straps and a method of using them that are easier to use.

### SUMMARY OF THE INVENTION

One aspect of the disclosure relates to an axle strap that includes a strap, a first end piece disposed on a first end of the strap, and a second end piece disposed on a second end of the strap; wherein the first end piece and the second end piece are capable of coupling. The strap can be made of a high-strength fabric, and the first end of the strap and the second end of the strap can be looped. In an embodiment, the end pieces are made of a ferromagnetic material, preferably an iron alloy such as steel, and the coupling is ferromagnetic coupling. To obtain sufficient magnetic attraction one or more permanent magnet can be used. In an another embodiment, the end pieces can be coupled by hook-and-loop fasteners attached to the ends of the strap adjacent the end pieces.

Another aspect of the disclosure relates to a method of using the axle strap to tie down a vehicle, comprising the steps of wrapping the axle strap around a part of a vehicle; magnetically coupling the first end piece and the second piece of the strap; and hooking a tie down anchor to the first end piece and the second piece. The step of magnetically coupling can include making an audible clicking sound to alert the user of the coupling.

### BRIEF DESCRIPTION OF THE DRAWINGS

For further understanding of the disclosure, reference will be made to the following detailed description of the invention, which is accompanied with the following drawings:

FIG. 1 illustrates an example axle strap, according to an embodiment;

FIG. 2 illustrates end pieces of the axle strap hooked by a ratchet strap;

FIG. 3 illustrates an end piece of the axle strap including a pair of permanent magnets, according to an embodiment;

FIG. 4 illustrates a magnet holder for holding the permanent magnets;

FIG. 5 illustrates the magnet holder with the pair of the permanent magnets attached thereto; and

FIG. 6 illustrates an example axle strap, according to another embodiment.

### DETAILED DESCRIPTION OF THE INVENTION

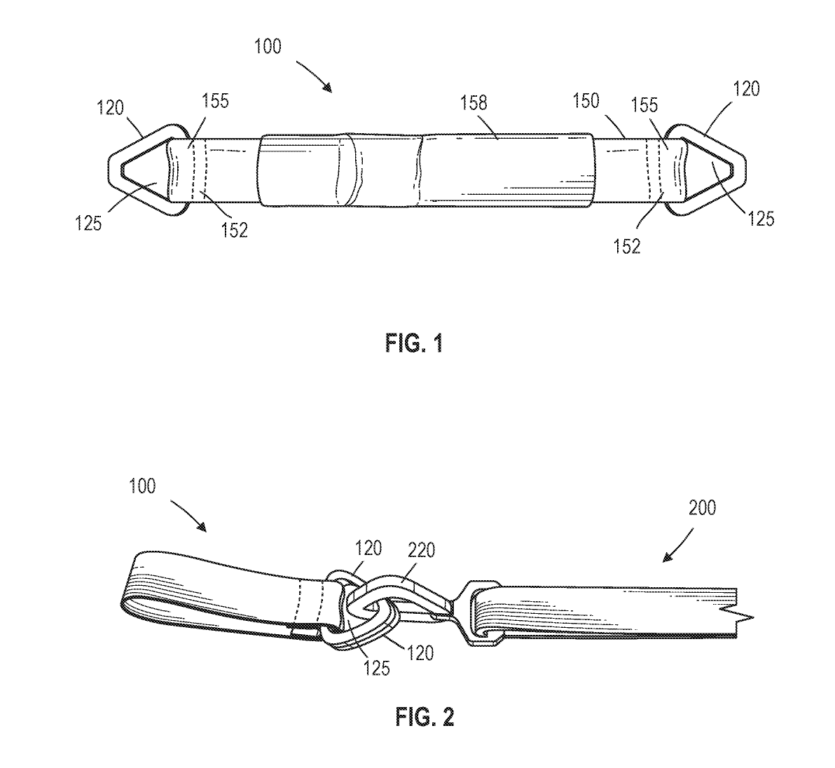

FIG. 1 illustrates an example axle strap 100, according to an embodiment. The axle strap 100 includes a strap 150 that is made of a high-strength material, such as multiple-ply nylon or polyester fabric preferably having a working load limit (WLL) of at least about 3,000 lbs. The strap 150 can include a reinforcement portion 158 which can include an additional layer of material attached to the strap 150. Additionally, the strap 150 can be treated with a weather-resistant coating. On each end of the strap 150 is a looped end 155 that can be formed by folding over an end portion of the strap 100 onto itself. The looped ends 155 can be secured with stitching 152 or the like. The end pieces 120 can be attached to the looped ends 155, as shown. The end pieces 120 are made of a ferromagnetic material, preferably an iron alloy such as steel. The end pieces 120 can be substantially identical and shaped to accommodate a hook-type fastener or the like. The end pieces 120 can be D-shaped (as shown), O-shaped, triangular, or include a keyhole design, for example. As will be described in greater detail, the end pieces 120 are magnetically attracted to one another so as to make it easier to join the end pieces 120 preparatory to attaching a hook or the like to the end pieces 120.

FIG. 2 illustrates the end pieces 120 of the axle strap 100 being hooked by an example ratchet strap 200. As shown, the end pieces 120 are ferromagnetically joined and a hook 220 passes through the interior 125 of the end pieces. It is to be understood that in operation, the axle strap 100 would be wrapped around a portion of an object, such as an axle of a vehicle. The end pieces 120 would then be magnetically joined. This could be done by touching the end pieces 120 together. The magnetic coupling may cause an audible clicking sound to alert the user of the coupling. Finally, a ratchet strap 200 or other type of tie down anchor would be tightened until the vehicle is securely tied down. The ratchet strap 200 could be attached to the trailer of a tow truck, for example.

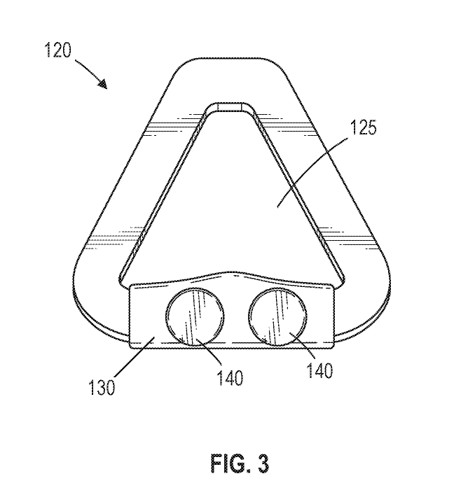

FIG. 3 illustrates an end piece 120 including a pair of permanent magnets 140, according to an embodiment. The permanent magnets 140 are attached to an example magnet holder 130 that clamps onto a portion of the end piece that is hidden from view. The permanent magnets 140 can be attached to the magnet holder 130 by magnetic attraction or using an adhesive, for example. For illustrative purposes, the magnet holder 130 is shown with two permanent magnets 140. However, it is to be understood that fewer or greater than two magnets may suffice. Furthermore, it is to be understood that in other embodiments, the magnet holder 130 is not used; instead, the permanent magnets 140 are attached directly to the end pieces 120.

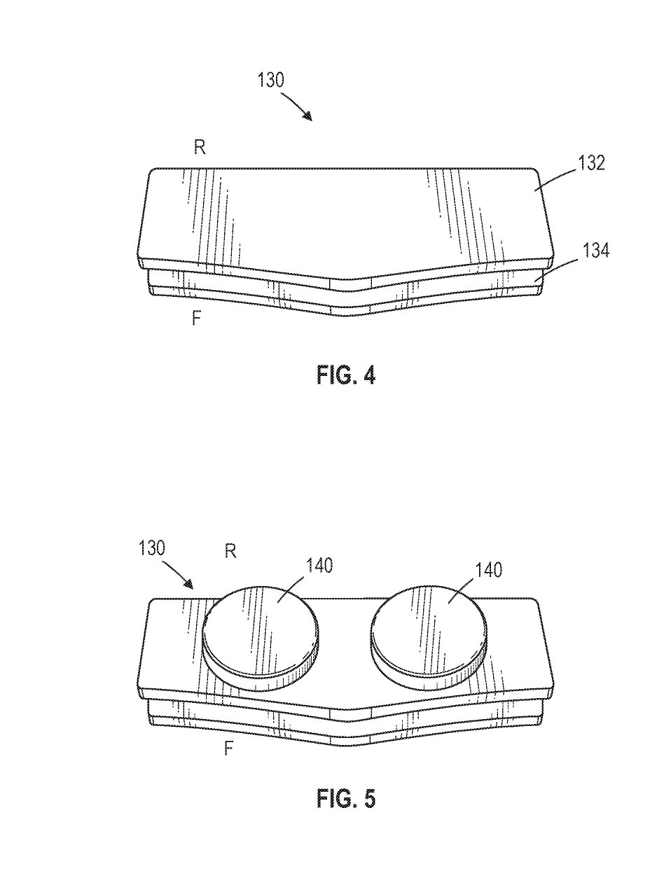

FIG. 4 illustrates the example magnet holder 130 for holding the permanent magnets 140. As shown, the magnet holder has a rear (R) side and a front (F) side. The front (F) side includes an opening 134, but the rear (R) side does not have a similar opening. In this embodiment, the magnet holder is a C-clamp. FIG. 5 illustrates the magnet holder 130 with the pair of permanent magnets 140 attached thereto.

Although embodiments of the axle strap 100 described above employ permanent magnets 140 to provide the necessary ferromagnetic attraction, it is to be understood that the end pieces themselves could instead be magnetized using one of several known processes, such as, for example, by direct induction. Additionally, although each of the end pieces 120 includes magnets 140, it is to be understood that only one of the end pieces 120 could include magnets 140. In this case, the magnetic attraction would occur between the end piece 120 having the magnets 140 and the ferromagnetic material of the other end piece 120 lacking the magnets. Furthermore, it is to be understood that when both end pieces 120 include the permanent magnets, the permanent magnets 140 must be strong enough to allow the end pieces 120 to stay joined at least during the time it takes the user to grasp the joined end pieces 120. Additionally, the permanent magnets 140 should also be arranged such that one of the end pieces 120 includes a magnetic polarity opposite to the other to achieve the necessary magnetic attraction.

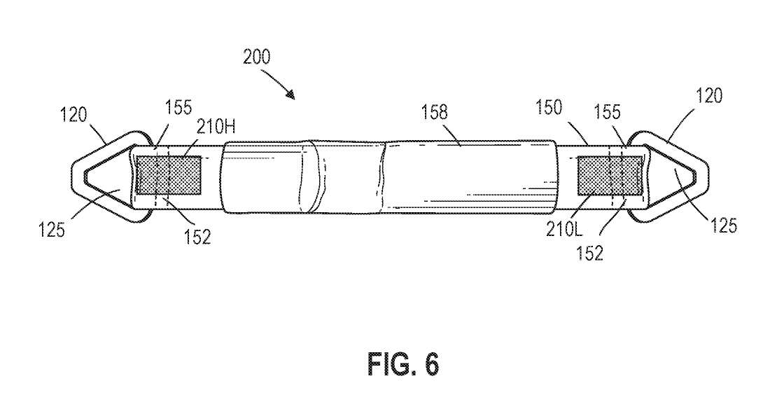

FIG. 6 illustrates an example axle strap 200, according to another embodiment. The main difference between the axle strap 100 and the axle strap 200 is that the end pieces 120 of axle strap 100 achieve coupling by ferromagnetic attraction while the end pieces 120 of the axle strap 200 are joined by hook-and-loop fastening (e.g., by using VELCRO™). More particularly, a patch of hook material 210-H can be placed on the strap 150 near an end piece 120 and a patch of loop material 210-L can be placed on the opposite end of the strap 150 (on the same side), such that when the axle strap 200 is folded the hook material 210-H and the loop material 210-L come into sufficient contact so the end pieces 120 are coupled.

It is to be understood that although attachment to an axle is discussed above, the axle strap can be wrapped around other parts of a vehicle such as a control arm or frame. Furthermore, it is to be understood that the axle strap can be used to tie down various other types of vehicles, including ATV/UTVs, motorcycles, trucks, boats, snowmobiles, as well as be used for securing cargo, stored items, etc.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

1. An axle strap, comprising:
a strap;
a first end piece shaped to accommodate a hook-type fastener and disposed on a first end of the strap;
a second end piece shaped to accommodate a hook-type fastener and disposed on a second end of the strap; and
a coupling feature for holding the first end piece and the second end piece in alignment to facilitate engaging both the first end piece and the second end piece with a hook-type fastener.

2. The axle strap of claim 1, wherein the strap is made of a fabric and the first end of the strap and the second end of the strap are looped.

3. The axle strap of claim 2, wherein each of the first end piece and the second end piece is attached to the strap using respective ones of the loop ends.

4. The axle strap of claim 1, wherein at least one of the first end piece and the second end piece are is made of a ferromagnetic metal and the coupling feature includes ferromagnetic coupling.

5. The axle strap of claim 1, wherein the coupling feature includes a patch of hook material on the first end of the strap and a patch of loop material on the second end of the strap, the hook material and loop material engaging each other in a hook-and-loop coupling.

6. The axle strap of claim 1, wherein the first end piece and the second end piece are substantially identical.

7. The axle strap of claim 1, wherein the first end piece and the second end piece are D-shaped, O-shaped, triangular, or include a keyhole design.

8. The axle strap of claim 1, wherein the axle strap is an axle strap for tying down a motor vehicle.

9. The axle strap of claim 1, wherein the coupling feature includes at least one permanent magnet attached to one or more of the first end piece and the second end piece.

10. The axle strap of claim 9, wherein the at least one permanent magnet is hidden from view underneath a looped end of the strap.

11. An axle strap, comprising:
a strap;
a first end piece disposed on a first end of the strap; and
a second end piece disposed on a second end of the strap;
wherein the first end piece and the second end piece are made of a ferromagnetic metal and are ferromagnetically attracted to each other.

12. The axle strap of claim 11, wherein the strap has a working load limit of at least about 3,000 lbs.

13. The axle strap of claim 11, wherein the first end piece and the second end piece are substantially identical.

14. The axle strap of claim 11, wherein the first end piece and the second end piece are D-shaped, O-shaped, triangular, or include a keyhole design.

15. The axle strap of claim 11, wherein the axle strap is an axle strap for tying down a motor vehicle.

16. A method for using a magnetic axle strap to tow a vehicle, comprising the steps of:
wrapping the axle strap of claim 11 around a part of a vehicle; magnetically coupling the first end piece and the second piece of the strap;
attaching a tie-down anchor to the first end piece and the second piece.

17. The method of claim 16, wherein the part of a vehicle is an axle of the vehicle.

18. The method of claim 16, wherein the tie-down anchor includes a ratchet strap.

19. The method of claim 18, wherein the ratchet strap is a hooked ratchet strap.

20. The method of claim 16, the step of magnetically coupling includes making an audible clicking sound to alert the user of the coupling.

21. The axle strap of claim 4, wherein the coupling feature includes magnetizing the ferromagnetic material of at least one of the first and second end pieces to generate a magnetic attraction between the first and second end pieces.
